(19) United States
(12) Patent Application Publication
(10) Pub. No.: US 2015/0090038 A1
(43) Pub. Date: Apr. 2, 2015

(54) VIBRATION TESTING DEVICE

(71) Applicant: Kun-Ta LEE, New Taipei City (TW)

(72) Inventor: Kun-Ta LEE, New Taipei City (TW)

(21) Appl. No.: 14/247,677

(22) Filed: Apr. 8, 2014

(30) Foreign Application Priority Data
Oct. 2, 2013 (TW) 102218468

(51) Int. Cl. G01N 29/32; G01N 29/34

(52) U.S. Cl. CPC G01N 29/326; G01N 29/34; G01N 2291/028
USPC 73/663

(57) ABSTRACT

A vibration testing device with a platform, a vibration assembly, a housing and a cooling system is provided. The platform is adapted to hold a test object. The vibration assembly is adapted to force a vibration to the platform. The housing has an inlet end and an outlet end opposite the inlet end. The housing is disposed under the platform and covers the vibration assembly. The cooling system with a fan and an atomizing assembly, and is disposed on the housing. The fan is adapted to generate an airflow. The atomizing assembly is adapted to generate atomized water. The airflow with the atomized water passes through the inlet end, the interior of the housing and the outlet end sequentially to reduce the working temperature of the vibration assembly.

This application claims the benefit from the priority to Taiwan Patent Application No. 102218468 filed on Oct. 2, 2013, the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to a vibration testing device; and more particularly, the present invention relates to a vibration testing device comprising a water cooling system.

2. Descriptions of the Related Art

Various products that are used in everyday lives may be subjected to random vibrations or disturbances, e.g., vibrations generated by the movement of vehicles, disturbances generated by airplanes in airflow, or random vibrations generated during the handling process of machines. When the products are exposed to such vibrations for a long period of time, predetermined functions of the products may be negatively affected if no appropriate design is made. Therefore, before putting the products onto the market, manufacturers must make a simulated vibration test for a period of time to validate the reliability of the product design thereof.

FIG. 1 shows a vibration testing device 100 that is used for performing the aforesaid simulated vibration test. The device is mainly comprised of a platform 110, a vibration assembly 120 and a housing 130. The platform 110 is adapted to hold the product (i.e., a test object), while the vibration assembly 120 is adapted to apply vibrations to the product. The housing 130 is adapted to cover the vibration assembly 120 to isolate the vibration assembly 120 from the external environment.

However, since the vibration assembly 120 is covered by the housing 130, the waste heat that is generated by the repeated vibrations of the vibration assembly 120 is trapped in the housing 130 during the simulated vibration test, which will affect the service life of the vibration assembly 120.

The simulated vibration test requires long-time repeated actions, so if the generated waste heat cannot be removed effectively during the simulated vibration test, the material temperature will rise and degrade the material strength. Furthermore, the original characteristics of the high-permeability materials will degrade under high temperatures. In addition, normal operations of the vibration assembly 120 will be severely compromised, which will adversely affect the accuracy of the simulated vibration test and shorten the service life of the vibration testing device 100.

Moreover, high temperatures from the accumulation of the waste heat increase the resistance of the coils inside the vibration assembly 120. As a result, a higher power (voltage) is required to supply an equal current adapted to generate a push force for testing. That is, when the resistance is increased because of the increased temperature, copper wires will be severely oxidized to cause increased electrical resistivity, which in turn increases the power consumption of the simulated test to cause dramatic waste of electrical power.

Accordingly, it is important to effectively remove the waste heat generated during the operation of the vibration assembly 120 or other elements of the vibration testing device 100 to prolong the service life of the vibration testing device and reduce the power consumption of the simulated test by rapidly reducing the operating temperature of the vibration testing device.

### SUMMARY OF THE INVENTION

An objective of the present invention is to provide a vibration testing device, which has a water cooling system that can effectively absorb the waste heat generated by a vibration assembly or other elements to achieve the effect of reducing the operating temperature thereof.

Another objective of the present invention is to provide a vibration testing device that has a water cooling system that can reduce the resistance of coils of the vibration assembly while reducing the working temperature of the vibration assembly, thereby reducing the power consumption of the vibration assembly.

To achieve the aforesaid objectives, a vibration testing device that is provided in the present invention comprises a platform, a vibration assembly, a housing, and a water cooling system. The platform is utilized for holding a test object. The vibration assembly is adapted to force a vibration to the platform. The housing has an inlet end and an outlet end opposite the inlet end. The housing is disposed under the platform and is utilized for covering the vibration assembly. The water cooling system has a fan and an atomizing assembly. The fan is disposed at the outlet end of the housing, while the atomizing assembly is disposed at the inlet end of the housing. The fan is adapted to generate an airflow through the inlet end, the interior of the housing and the outlet end sequentially. The atomizing assembly is adapted to generate atomized water, and is thus guided by the airflow through the inlet end, the interior of the housing and the outlet end sequentially to reduce the working temperature of the vibration assembly.

To achieve the aforesaid objectives, the inlet end of the vibration testing device provided in the present invention is disposed on the upper portion of the housing. The outlet end is disposed on the lower portion of the housing.

To achieve the aforesaid objectives, the inlet end and the outlet end of the vibration testing device provided in the present invention has at least one inlet and at least one outlet respectively.

To achieve the aforesaid objectives, the vibration testing device in the present invention further comprises an air supply system. The air supply system is disposed at the inlet end to facilitate flow of the airflow.

To achieve the aforesaid objectives, the water cooling system of the vibration testing device provided in the present invention further comprises a control unit for controlling the strength of the airflow generated by the fan and the amount of atomized water generated by the atomizing assembly.

To achieve the aforesaid objectives, the vibration assembly of the vibration testing device provided in the present invention comprises at least one vibration unit.

To achieve the aforesaid objectives, the vibration testing device provided in the present invention further comprises a plurality of transformers disposed in the housing.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a vibration testing device used in the prior art;

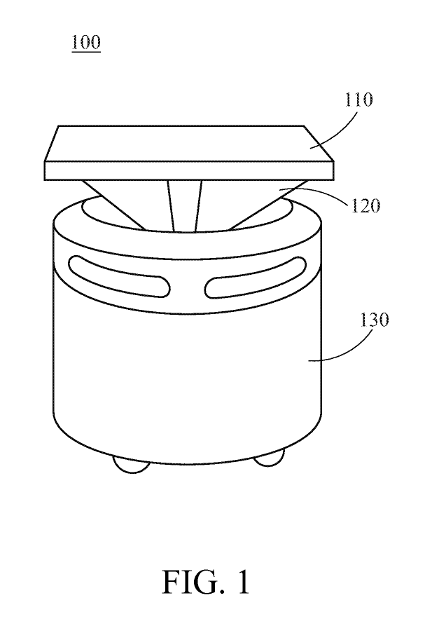

FIG. 2 shows a top view and a schematic cross-sectional view of a vibration testing device of the present invention;

FIG. 3 is a schematic view illustrating the flow of the airflow that is generated by the water cooling system of the vibration testing device of the present invention in the vibration testing device; and

FIG. 4 is a schematic cross-sectional view of a vibration testing device installed with an air supply system according to the present invention.

### DESCRIPTION OF THE PREFERRED EMBODIMENT

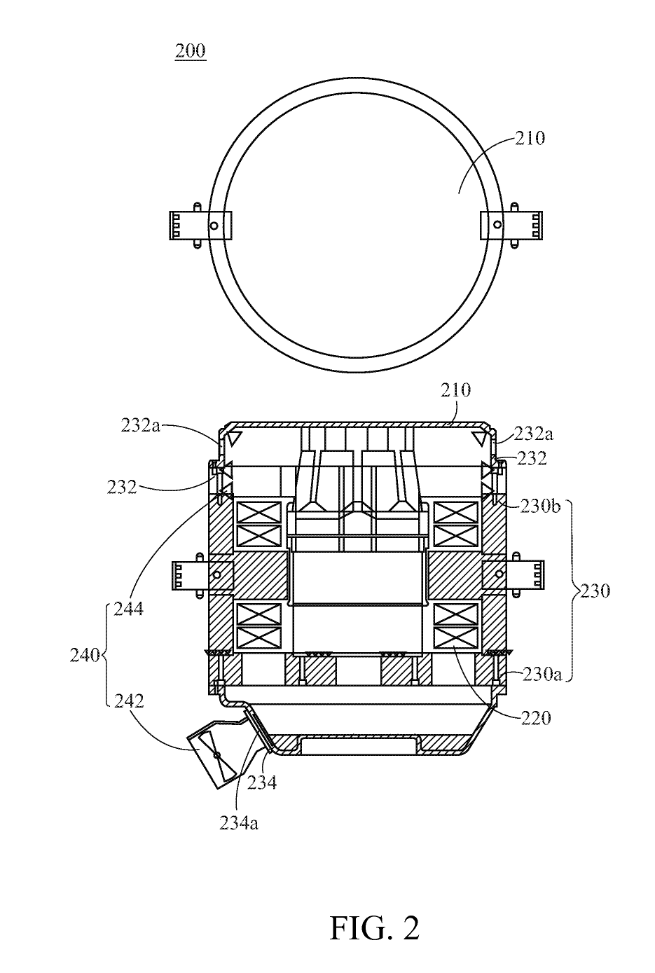

As shown in FIG. 2, a vibration testing device 200 of the present invention comprises a platform 210, a vibration assembly 220, a housing 230, and a water cooling system 240.

The platform 210 is utilized for holding a test object (not shown). The vibration assembly 220 is adapted to force a vibration to the platform 210. The housing 230 has an inlet end 232 and an outlet end 234 opposite the inlet end 232. As shown in FIG. 2, the housing 230 is preferably disposed under the platform 210 and is utilized for covering the vibration assembly 220 to isolate the vibration assembly 220 from the external environment so that the vibration assembly 220 is prevented from being subjected to external impact or interference during its operation.

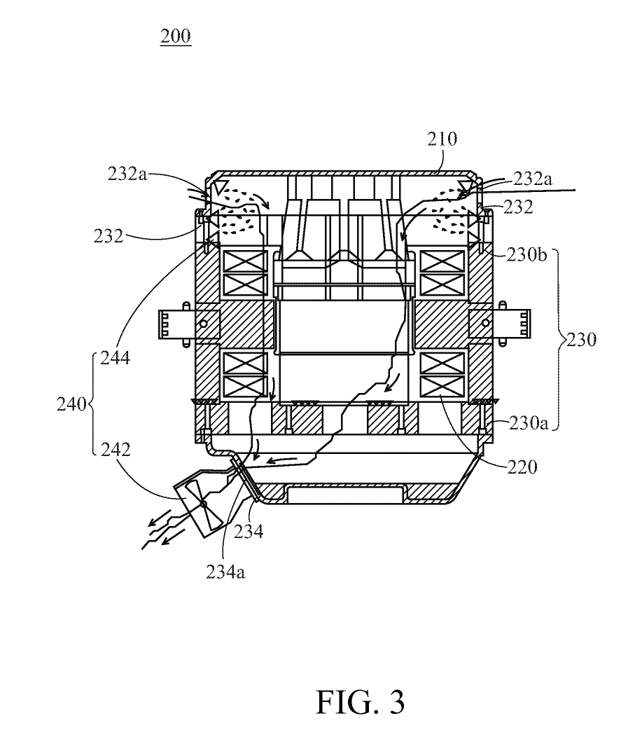

The water cooling system 240 has a fan 242 and an atomizing assembly 244. The fan 242 is disposed at the outlet end 234 of the housing 230. The atomizing assembly 244 is disposed at the inlet end 232 of the housing 230. With reference to FIG. 3, when the fan 242 operates at the outlet end 234 disposed on the lower portion of the housing 230 to draw air, an airflow is formed. After being drawn in through the inlet end 232 from the external environment, the airflow is drawn out through the inlet end 232, the interior of the housing 230 and the outlet end 234 sequentially to replace the hot air inside the housing 230 with the cold air from the external environment.

On the other hand, the atomizing assembly 244 is disposed at the inlet end 232 of the housing 230 and is adapted to generate atomized water. When the airflow flows from the housing 230 downwards through the inlet end 232, the interior of the housing 230 and the outlet end 234 sequentially, the atomized water will be guided by the airflow. In this way, the airflow containing the atomized water can be utilized to absorb the waste heat generated by the vibration assembly 220 and other elements of the vibration testing device 200 during the simulated vibration test to further reduce the operating temperature of the vibration testing device 200.

Furthermore, in the preferred embodiment of the present invention, the inlet end 232 is disposed on an upper portion 230b of the housing 230, while the outlet end 234 is disposed on a lower portion 230a of the housing 230. The inlet end 232 and the outlet end 234 have at least one inlet 232a and at least one outlet 234a respectively.

As shown in embodiments FIGS. 2 and 3, in an aspect where the inlet end 232 has a plurality of inlets 232a and the outlet end 234 has a single outlet 234a, the atomizing assembly 244 is disposed at the plurality of inlets 232a so that the atomized water generated by the atomizing assembly 244 will effectively absorb the waste heat generated by the vibration assembly 220 and other elements of the vibration testing device 200 while the atomized water flows through the exterior of the housing 230. In this way, the objective of rapidly reducing the working temperature of the vibration testing device 200 is achieved.

In the embodiments of the present invention, other elements of the vibration testing device 200 may comprise a plurality of transformers (not shown). The vibration assembly 220 may comprise at least one vibration unit (not shown). Both the aforesaid plurality of transformers and the vibration unit have a coil assembly therein. A large portion of the aforesaid waste heat is from these coil assemblies. Therefore, the main objective of disposing the water cooling system 240 is to reduce the temperature of the coil assemblies inside the plurality of transformers and the vibration unit.

It shall be appreciated that the atomized water generated by the atomizing assembly 244 may be little drops or water molecules of a small volume such as water mists, so when the atomized water is guided by the airflow generated by the air drawing operation of the fan 242 to the interior of the housing 230, the small-volume water molecules in a liquid phase will evaporate rapidly after absorbing the waste heat. In other words, while the water cooling system 240 of the present invention is reducing the working temperature of the vibration testing device 200, the atomized water generated by the atomizing assembly 244 will be evaporated rapidly from the liquid phase to the gas phase after absorbing the waste heat. Hence, the atomized water will not remain in the vibration assembly 220 or the vibration unit thereof or remain in the plurality of transformers or other elements of the vibration testing device 200. Therefore, there is no need to worry about that the vibration assembly 220 or the vibration unit thereof or the plurality of transformers or other elements of the vibration testing device 200 would get rusty or be short-circuited.

As indicated by experimental data, when a particular vibration testing device 200 is used for the vibration test at room temperature, the working temperature of the coil assemblies of the transformers thereof or the coil assemblies inside the vibration unit of the vibration assembly 220 is about 200° C. However, when the water cooling system 240 of the present invention is used to cool the vibration testing device 200, the working temperature of the aforesaid coil assemblies can be reduced by 70° C.-80° C. to a range of 120° C.-130° C. to provide extremely effective cooling services for the vibration testing device 200.

Furthermore, the main material of the aforesaid coil assemblies is copper and the resistance R of copper is directly proportional to the temperature T, so when the water cooling system 240 of the present invention is used to cool the vibration testing device 200 so that the aforesaid coil assemblies have a relatively low working temperature, it also helps to reduce the resistance of the coil assemblies at the same time. As a result, in the case of an equal current, the voltage that is required to be applied to the coil assembly will be decreased because the resistance is reduced. That is, when the working temperature of the coil assembly is reduced, the resistance of the coil assembly will be decreased accordingly. The decreased resistance helps to lower the energy consumption per unit time, which allows for saving energy of the vibration testing device 200 provided with the water cooling system 240 of the present invention therein during the simulated vibration test.

The water cooling system 240 may further comprise a control unit (not shown) to monitor the working temperature of the vibration testing device 200. The control unit is further configured to adjust the strength of the airflow generated by the air drawing operation of the fan 242 and adjust the water amount of the atomized water generated by the atomizing assembly 244 to precisely control the cooling efficiency of the water cooling system 240 and simultaneously maintain the best working temperature of the vibration testing device 200.

The positions of the aforesaid inlet end 232 and the outlet end 234 may be adjusted according to the demands. For example, the inlet end 232 may be disposed on the lower portion of the housing 230 while the outlet end 234 may be disposed on the upper portion of the housing 230, but they are not limited thereto.

Moreover, the number of the inlets 232a of the inlet end 232, the number of the outlets 234a of the outlet end 234, the number of the fans 242 and the number of the atomizing assemblies 244 can all be adjusted and varied correspondingly depending on different types of the vibration testing device and the amount of the waste heat that might be generated during the simulated vibration test, so they are not limited herein.

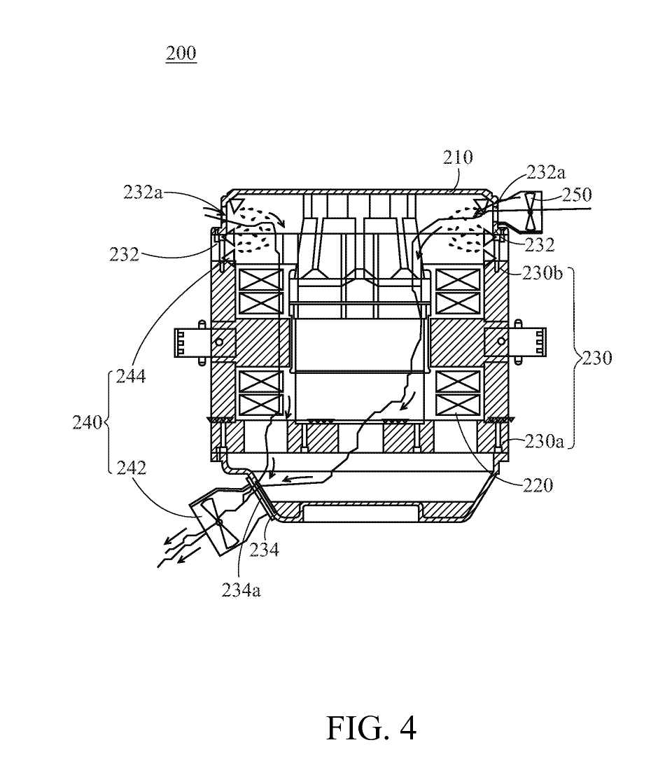

On the other hand, in another embodiment as shown in FIG. 4, the vibration testing device 200 of the present invention may further comprise an air supply system 250 disposed in the inlet end 232 to cooperate with the fan 242 disposed in the outlet end 234. That is, in the embodiment of FIG. 4, the flowing velocity of the airflow containing the atomized water inside the housing 230 is accelerated through the arrangement in which one end is used to draw the air (the fan 242 draws the air from the outlet end 234) and the other end is used to supply the air (the air supply system 250 supplies the air from the inlet end 232). In this way, the exchanging velocity between the cold air outside the housing 230 and the hot air inside the housing 230 is accelerated, and the objective of effectively reducing the operating temperature of the vibration testing device 200 is achieved.

As compared with the conventional cooling manner which only uses the air for cooling, the vibration testing device 200 of the present invention comprises the water cooling system 240. Therefore, at the same environment temperature, the vibration testing device 200 of the present invention can remove the waste heat generated by the vibration testing device during the simulated vibration test in a shorter time period, or can allow the elements of the vibration testing device to maintain a relatively lower working temperature for a long time as compared with the conventional vibration testing machines, thereby prolonging the service life of each element.

As mentioned above, when the working temperatures of the coil assemblies of the transformers included in the vibration testing device 200 and the coil assembly of the vibration unit inside the vibration assembly 220 are relatively low, the resistance thereof will decrease accordingly. In this way, the energy consumed per unit time will be reduced effectively so that the vibration testing device 200 provided with the water cooling system 240 of the present invention can also achieve the energy saving effect.

According to the above descriptions, with the water cooling system 240 of the vibration testing device 200 of the present invention, the waste heat generated by the vibration assembly 220 or other elements during the simulated vibration test will be absorbed effectively by the airflow that contains the atomized water generated by the water cooling system 240. The operating temperature of the vibration testing device 200 of the present invention is reduced and, meanwhile, the service life of the elements is prolonged and the energy saving effect is achieved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A vibration testing device, comprising:
a platform for holding a test object;
a vibration assembly, adapted to force a vibration to the platform;
a housing having an inlet end and an outlet end opposite the inlet end, the housing being disposed under the platform and utilized for covering the vibration assembly; and
a water cooling system having a fan and an atomizing assembly, the fan being disposed at the outlet end of the housing, and the atomizing assembly being disposed at the inlet end of the housing;
wherein the fan is adapted to generate an airflow through the inlet end, the interior of the housing and the outlet end sequentially, the atomizing assembly is adapted to generate atomized water, and the atomized water is thus guided by the airflow through the inlet end, the interior of the housing and the outlet end sequentially to reduce a working temperature of the vibration assembly.

2. The vibration testing device as claimed in claim 1, wherein the inlet end is disposed on an upper portion of the housing, and the outlet end is disposed on a lower portion of the housing.

3. The vibration testing device as claimed in claim 2, wherein the inlet end and the outlet end have at least one inlet and at least one outlet respectively.

4. The vibration testing device as claimed in claim 1, further comprising an air supply system disposed at the inlet end.

5. The vibration testing device as claimed in claim 1, wherein the water cooling system further comprises a control unit for controlling the strength of the airflow generated by the fan, and control the water amount of the atomized water generated by the atomizing assembly.

6. The vibration testing device as claimed in claim 1, wherein the vibration assembly comprises at least one vibration unit.

7. The vibration testing device as claimed in claim 1, further comprising a plurality of transformers disposed in the housing.
